(19) United States
(12) Patent Application Publication
(10) Pub. No.: US 2020/0143025 A1
(43) Pub. Date: May 7, 2020

(54) System, Method, and Apparatus for Authenticating Biometric Inputs

(71) Applicant: Visa International Service Association, San Francisco, CA (US)

(72) Inventor: Chandra Bhan GIRI, Bareilly (IN)

(21) Appl. No.: 16/627,184

(22) PCT Filed: Jun. 29, 2017
(86) PCT No.: PCT/US2017/039905

§ 371 Date: Dec. 27, 2019

(51) Int. Cl. G06F 21/32

(52) U.S. Cl. CPC G06F 21/32; G06F 2221/2117

(57) ABSTRACT

Provided is a computer-implemented method for authenticating biometric inputs on a client device. The method includes the steps of generating, with the client device, a first biometric code based at least partially on at least one first biometric input and at least one code received from an external system, and storing the first biometric code on the client device. The method further includes receiving, on the client device, the at least one code from an external system, generating, with the client device, a second biometric code based at least partially on at least one second biometric input and the at least one code, comparing, on the client device, the first biometric code to the second biometric code, and authenticating the user in response to determining that the first biometric code matches the second biometric code. A system and computer program product for authenticating biometric inputs are also disclosed.

### BACKGROUND OF THE INVENTION

### 1. Field of the Invention

This invention relates generally to biometric authentication and, in one particular embodiment, to a system, method, and apparatus for authenticating biometric inputs.

### 2. Technical Considerations

Existing biometric authentication systems enable users to authenticate themselves by providing a biometric input, such as a fingerprint. In such existing biometric authentication systems, a user's biometric input is provided to a remote server where it is compared with a stored biometric input for that user that was previously provided to the remote server. Such an arrangement, even if the biometric input is encrypted before being transmitted, exposes the user's biometric input to potentially vulnerable remote systems. Because a user cannot change his or her biometric inputs as a user would change a compromised password, a compromised biometric input can have a lifelong effect on the user's ability to securely engage in transactions.

U.S. Pat. No. 9,286,457 to Beatson et al. (the “Beatson patent”) describes encrypting biometric data on a mobile device using hardware elements of the mobile device and a PIN value. The Beatson patent describes using an Application Specific Integrated Circuit (ASIC) in a mobile device to provide a mobile device ID that is used to generate a PIN value. A user provides a password which is obfuscated with a hashed value of the generated PIN value or mobile device ID. The obfuscated password is stored on the mobile device or ASIC. A biometric template is then generated from biometric data and encrypted using the hashed value of the generated PIN. The encrypted biometric template is stored on the mobile device or ASIC and is used for authentication. The system described by the Beatson patent is specific and central to the mobile device. If the client device or PIN is compromised in this arrangement, an intruder could potentially reverse engineer the encrypted biometric and/or otherwise engage in unauthorized transactions.

### SUMMARY OF THE INVENTION

Accordingly, it is an object of the present invention to provide a system, method, and apparatus for authenticating biometric inputs that overcomes some or all of the deficiencies of the prior art.

According to a non-limiting embodiment, provided is a computer-implemented method of authenticating biometric inputs on a client device, comprising: receiving, on the client device, at least one first biometric input from a user; receiving, on the client device, at least one code from an external system; generating, with the client device, a first biometric code based at least partially on the at least one first biometric input and the at least one code; storing the first biometric code on the client device; receiving, on the client device, at least one second biometric input from the user; receiving, on the client device, the at least one code from an external system; generating, with the client device, a second biometric code based at least partially on the at least one second biometric input and the at least one code; and authenticating the user by comparing, with the client device, the first biometric code stored on the client device with the second biometric code.

In non-limiting embodiments, the method further comprises initiating, with the client device, a transaction in response to authenticating the user. The transaction may comprise a payment transaction, and initiating the transaction may comprise generating, with the client device, a transaction message and communicating the transaction message to a transaction processing system. The transaction may comprise granting access to a facility, and initiating the transaction may comprise communicating an access signal to an electronic access device at the facility, the access signal configured to cause the electronic access device to unlock. The transaction may comprise granting access to a system, and initiating the transaction may comprise at least one of the following: communicating an access signal to a server, communicating an access signal to a local computer, communicating user credentials to a server, communicating user credentials to a local computer, communicating an access signal to an electronic access device, or any combination thereof.

In non-limiting embodiments, the first biometric code is generated by hashing the at least one first biometric input with the at least one code, and the second biometric code is generated by hashing the at least one second biometric input with the at least one code. Further, in some non-limiting examples, the user is associated with a unique identifier, and the at least one code is selected from a plurality of codes based at least partially on the unique identifier.

According to another non-limiting embodiment, provided is a system for authenticating biometric inputs on a client device, comprising: (a) at least one data storage device; and (b) at least one processor in communication with the at least one data storage device and at least one biometric input device, the at least one processor programmed or configured to: (i) receive at least one first biometric input from a user via the at least one biometric input device; (ii) receive at least one code from an external system; (iii) generate a first biometric code based at least partially on the at least one first biometric input and the at least one code; (iv) store the first biometric code on the data storage device; (v) receive at least one second biometric input from the user via the at least one biometric input device; (vi) receive the at least one code from an external system; (vii) generate a second biometric code based at least partially on the at least one second biometric input and the at least one code; and (viii) authenticate the user by comparing the first biometric code stored on the at least one data storage device with the second biometric code.

In non-limiting embodiments, the at least one processor may be further programmed or configured to (ix) initiate a transaction in response to authenticating the user. The transaction may comprise a payment transaction, and the at least one processor may initiate the transaction by: generating a transaction message and communicating the transaction message to a transaction processing system. The transaction may comprise granting access to a facility, and the at least one processor may initiate the transaction by communicating an access signal to an electronic access device, the access signal configured to cause the electronic access device to unlock. The transaction may comprise granting access to a system, and the at least one processor may initiate the transaction by at least one of the following: communicating an access signal to a server, communicating an access signal to a local computer, communicating user credentials to a server, communicating user credentials to a local computer, communicating an access signal to an electronic access device, or any combination thereof.

In non-limiting embodiments, the user is associated with a unique identifier, and the at least one code is selected from a plurality of codes based at least partially on the unique identifier. Further, in non-limiting embodiments, the first biometric code is generated by hashing the at least one first biometric input with the at least one code, and the second biometric code is generated by hashing the at least one second biometric input with the at least one code.

According to another non-limiting embodiment, provided is a computer program product for authenticating biometric inputs on a client device, comprising at least one non-transitory computer-readable medium including program instructions that, when executed by at least one processor of a client device, cause the client device to: receive at least one first biometric input from a user via at least one biometric input device; receive at least one code from an external system; generate a first biometric code based at least partially on the at least one first biometric input and the at least one code; store the first biometric code on the client device; receive at least one second biometric input from the user via the at least one biometric input device; receive the at least one code from an external system; generate a second biometric code based at least partially on the at least one second biometric input and the at least one code; and authenticate the user by comparing the first biometric code stored on the client device with the second biometric code.

According to a further non-limiting embodiment, provided is a computer-implemented method of authenticating biometric inputs on a client device, comprising: generating, with the client device, a first biometric code based at least partially on at least one first biometric input and at least one code received from a system external to the client device; storing the first biometric code on the client device; in response to an authentication request, receiving, on the client device, the at least one code from a system external to the client device; generating, with the client device, a second biometric code based at least partially on at least one second biometric input and the at least one code; comparing, on the client device, the first biometric code to the second biometric code; and authenticating the user in response to determining that the first biometric code matches the second biometric code.

In non-limiting embodiments, generating the first biometric code comprises hashing the at least one first biometric input with the at least one code. In non-limiting embodiments, the method may further comprise initiating, with the client device, a transaction in response to authenticating the user. In non-limiting embodiments, initiating the transaction comprises at least one of the following: communicating a transaction message to a transaction processing system, communicating an access signal to an electronic access device at the facility, communicating an access signal to a server, communicating an access signal to a local computer, communicating user credentials to a server, communicating user credentials to a local computer, or any combination thereof.

According to a further non-limiting embodiment, provided is a computer program product for authenticating biometric inputs on a client device, comprising at least one non-transitory computer-readable medium including program instructions that, when executed by at least one processor of a client device, cause the client device to: generate a first biometric code based at least partially on at least one first biometric input and at least one code received from a system external to the client device; store the first biometric code on the client device; in response to an authentication request, receive the at least one code from a system external to the client device; generate a second biometric code based at least partially on at least one second biometric input and the at least one code; and authenticate the user by comparing the first biometric code with the second biometric code.

In non-limiting embodiments, the first biometric code is generated by hashing the at least one first biometric input with the at least one code. In non-limiting embodiments, the program instructions, when executed by the at least one processor, further cause the client device to initiate a transaction in response to authenticating the user. In non-limiting embodiments, the transaction is initiated by at least one of the following: communicating a transaction message to a transaction processing system, communicating an access signal to an electronic access device at the facility, communicating an access signal to a server, communicating an access signal to a local computer, communicating user credentials to a server, communicating user credentials to a local computer, or any combination thereof.

Further preferred and non-limiting embodiments or aspects are set forth in the following numbered clauses.

Clause 1: A computer-implemented method of authenticating biometric inputs on a client device, comprising: receiving, on the client device, at least one first biometric input from a user; receiving, on the client device, at least one code from an external system; generating, with the client device, a first biometric code based at least partially on the at least one first biometric input and the at least one code; storing the first biometric code on the client device; receiving, on the client device, at least one second biometric input from the user; receiving, on the client device, the at least one code from an external system; generating, with the client device, a second biometric code based at least partially on the at least one second biometric input and the at least one code; and authenticating the user by comparing, with the client device, the first biometric code stored on the client device with the second biometric code.

Clause 2: The computer-implemented method of clause 1, further comprising initiating, with the client device, a transaction in response to authenticating the user.

Clause 3: The computer-implemented method of any of clauses 1 or 2, wherein the transaction comprises a payment transaction, and wherein initiating the transaction comprises: generating, with the client device, a transaction message; and communicating the transaction message to a transaction processing system.

Clause 4: The computer-implemented method of any of clauses 1-3, wherein the transaction comprises granting access to a facility, and wherein initiating the transaction comprises communicating an access signal to an electronic access device at the facility, the access signal configured to cause the electronic access device to unlock.

Clause 5: The computer-implemented method of any of clauses 1-4, wherein the transaction comprises granting access to a system, and wherein initiating the transaction comprises at least one of the following: communicating an access signal to a server, communicating an access signal to a local computer, communicating user credentials to a server, communicating user credentials to a local computer, communicating an access signal to an electronic access device, or any combination thereof.

Clause 6: The computer-implemented method of any of clauses 1-5, wherein the first biometric code is generated by hashing the at least one first biometric input with the at least one code, and wherein the second biometric code is generated by hashing the at least one second biometric input with the at least one code.

Clause 7: The computer-implemented method of any of clauses 1-6, wherein the user is associated with a unique identifier, and wherein the at least one code is selected from a plurality of codes based at least partially on the unique identifier.

Clause 8: A system for authenticating biometric inputs on a client device, comprising: (a) at least one data storage device; (b) at least one biometric input device; and (c) at least one processor in communication with the at least one data storage device and the at least one biometric input device, the at least one processor programmed or configured to: (i) receive at least one first biometric input from a user via the at least one biometric input device; (ii) receive at least one code from an external system; (iii) generate a first biometric code based at least partially on the at least one first biometric input and the at least one code; (iv) store the first biometric code on the data storage device; (v) receive at least one second biometric input from the user via the at least one biometric input device; (vi) receive the at least one code from an external system; (vii) generate a second biometric code based at least partially on the at least one second biometric input and the at least one code; and (viii) authenticate the user by comparing the first biometric code stored on the at least one data storage device with the second biometric code.

Clause 9: The system of clause 8, wherein the at least one processor is further programmed or configured to (ix) initiate a transaction in response to authenticating the user.

Clause 10: The system of any of clauses 8 or 9, wherein the transaction comprises a payment transaction, and wherein the at least one processor initiates the transaction by: generating a transaction message; and communicating the transaction message to a transaction processing system.

Clause 11: The system of any of clauses 8-10, wherein the transaction comprises granting access to a facility, and wherein the at least one processor initiates the transaction by communicating an access signal to an electronic access device, the access signal configured to cause the electronic access device to unlock.

Clause 12: The system of any of clauses 8-11, wherein the transaction comprises granting access to a system, and wherein the at least one processor initiates the transaction by at least one of the following: communicating an access signal to a server, communicating an access signal to a local computer, communicating user credentials to a server, communicating user credentials to a local computer, communicating an access signal to an electronic access device, or any combination thereof.

Clause 13: The system of any of clauses 8-12, wherein the user is associated with a unique identifier, and wherein the at least one code is selected from a plurality of codes based at least partially on the unique identifier.

Clause 14: The system of any of clauses 8-13, wherein the first biometric code is generated by hashing the at least one first biometric input with the at least one code, and wherein the second biometric code is generated by hashing the at least one second biometric input with the at least one code.

Clause 15: A computer program product for authenticating biometric inputs on a client device, comprising at least one non-transitory computer-readable medium including program instructions that, when executed by at least one processor of a client device, cause the client device to: receive at least one first biometric input from a user via at least one biometric input device; receive at least one code from an external system; generate a first biometric code based at least partially on the at least one first biometric input and the at least one code; store the first biometric code on the client device; receive at least one second biometric input from the user via the at least one biometric input device; receive the at least one code from an external system; generate a second biometric code based at least partially on the at least one second biometric input and the at least one code; and authenticate the user by comparing the first biometric code stored on the client device with the second biometric code.

Clause 16: A computer-implemented method of authenticating biometric inputs on a client device, comprising: generating, with the client device, a first biometric code based at least partially on at least one first biometric input and at least one code received from a system external to the client device; storing the first biometric code on the client device; in response to an authentication request, receiving, on the client device, the at least one code from a system external to the client device; generating, with the client device, a second biometric code based at least partially on at least one second biometric input and the at least one code; comparing, on the client device, the first biometric code to the second biometric code; and authenticating the user in response to determining that the first biometric code matches the second biometric code.

Clause 17: The computer-implemented method of clause 16, wherein generating the first biometric code comprises hashing the at least one first biometric input with the at least one code.

Clause 18: The computer-implemented method of any of clauses 16 or 17, further comprising initiating, with the client device, a transaction in response to authenticating the user.

Clause 19: The computer-implemented method of any of clauses 16-18, wherein initiating the transaction comprises at least one of the following: communicating a transaction message to a transaction processing system, communicating an access signal to an electronic access device at the facility, communicating an access signal to a server, communicating an access signal to a local computer, communicating user credentials to a server, communicating user credentials to a local computer, or any combination thereof.

Clause 20: A computer program product for authenticating biometric inputs on a client device, comprising at least one non-transitory computer-readable medium including program instructions that, when executed by at least one processor of a client device, cause the client device to: generate a first biometric code based at least partially on at least one first biometric input and at least one code received from a system external to the client device; store the first biometric code on the client device; in response to an authentication request, receive the at least one code from a system external to the client device; generate a second biometric code based at least partially on at least one second biometric input and the at least one code; and authenticate the user by comparing the first biometric code with the second biometric code.

Clause 21: The computer program product of clause 20, wherein the first biometric code is generated by hashing the at least one first biometric input with the at least one code.

Clause 22: The computer program product of any of clauses 20 or 21, wherein the program instructions, when executed by the at least one processor, further cause the client device to initiate a transaction in response to authenticating the user.

Clause 23: The computer program product of any of clauses 20-22, wherein the transaction is initiated by at least one of the following: communicating a transaction message to a transaction processing system, communicating an access signal to an electronic access device at the facility, communicating an access signal to a server, communicating an access signal to a local computer, communicating user credentials to a server, communicating user credentials to a local computer, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1A is a schematic diagram of a system for authenticating biometric inputs according to a non-limiting embodiment;

FIG. 1B is a schematic diagram of a system for authenticating biometric inputs according to another non-limiting embodiment;

FIG. 2 is a schematic diagram of a system for authenticating biometric inputs according to another non-limiting embodiment;

FIG. 3 is a flow diagram of a method for authenticating biometric inputs according to a non-limiting embodiment; and

FIG. 4 is a sequence diagram of a method for authenticating biometric inputs according to a non-limiting embodiment.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

Non-limiting embodiments of the present invention are directed to a system, method, and computer program product for authenticating biometric inputs. A first biometric code is generated based on a biometric input, such as a fingerprint, and at least one code received from an external system. The biometric code is stored on a client device and is used to authenticate biometric inputs. To begin a biometric authentication, a user provides a biometric input to the client device. The client device receives at least one code from an external system and, based on the at least one code and the biometric input, generates a second biometric code. The first biometric code, which is stored on the client device, is compared to the second biometric code to authenticate the user. The arrangement of storing a first biometric code on the client device, rather than only on a remote server, limits the potential for security breaches and compromises of a user's biometric input. The biometric input is also protected on the client device by being stored in encoded form as the biometric code. Moreover, by providing one or more codes from an external system to generate the biometric code, falsifying the biometric code is made technically difficult because specific data from at least two different sources is used. The arrangement of storing one or more codes on an external system, storing a first biometric code locally on a client device, and authenticating a transaction on the client device using a biometric input and one or more codes from the external system provides significant advantages and enhanced security over existing biometric authentication systems and methods.

As used herein, the term “transaction service provider” may refer to an entity that receives transaction authorization requests from merchants or other entities and provides guarantees of payment, in some cases through an agreement between the transaction service provider and an issuing institution. The term “transaction service provider” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” may refer to one or more entities, such as a bank, that provide accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions.

As used herein, the term “acquirer institution” may refer to an entity licensed by the transaction service provider and approved by the transaction service provider to originate transactions using a portable financial device of the transaction service provider. The transactions may include original credit transactions (OCTs) and account funding transactions (AFTs). The acquirer institution may be authorized by the transaction service provider to originate transactions using a portable financial device of the transaction service provider. The acquirer institution may contract with a payment gateway to enable the facilitators to sponsor merchants. An acquirer institution may be a financial institution, such as a bank. The terms “acquirer institution,” “acquirer bank,” and “acquirer system” may also refer to one or more computer systems operated by or on behalf of an acquirer institution, such as a server computer executing one or more software applications.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, an network-enabled appliance (e.g., a network-enabled television, refrigerator, thermostat, and/or the like), a computer, a point of sale (POS) system, and/or any other device or system capable of communicating with a network.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Wallet™, Android Pay™, Apple Pay®, Samsung Pay®, and/or other like electronic payment systems. In some non-limiting examples, an issuer bank may be an electronic wallet provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant, a security card, an access card, a wireless terminal, and/or a transponder, as examples. The portable financial device may include a volatile or a non-volatile memory to store information, such as an account identifier or a name of the account holder.

As used herein, the term “payment gateway” may refer to a payment processing system operated by or on behalf of an entity that contracts with an acquirer institution to provide transaction service provider payment services to one or more merchants using portable financial devices managed by the transaction service provider.

As used herein, the term “biometric input” may refer to any type of biometric data provided by a user such as, but not limited to, one or more of the following: a fingerprint, a retinal image, an iris image, a facial image, a hand geometry image, a verbal statement or response, a physiologic indicator, a DNA sample, a signature, and/or the like. A biometric input may include data received or provided by a biometric input device or, in other examples, may be processed in any number of ways and derived from data received or provided by a biometric input device. A biometric input may include one or more images, strings of characters (e.g., alphanumeric, binary, or hexadecimal representations), and/or any other form of data received from a biometric input device or derived from data received from a biometric input device. The term “biometric input device,” as used herein, may refer to one or more devices and/or systems for receiving and/or providing a biometric input. For example, a biometric input device may include one or more of the following: a fingerprint scanner, a retina and/or iris scanner, a camera, a microphone, a sensor, a touchscreen, and/or the like.

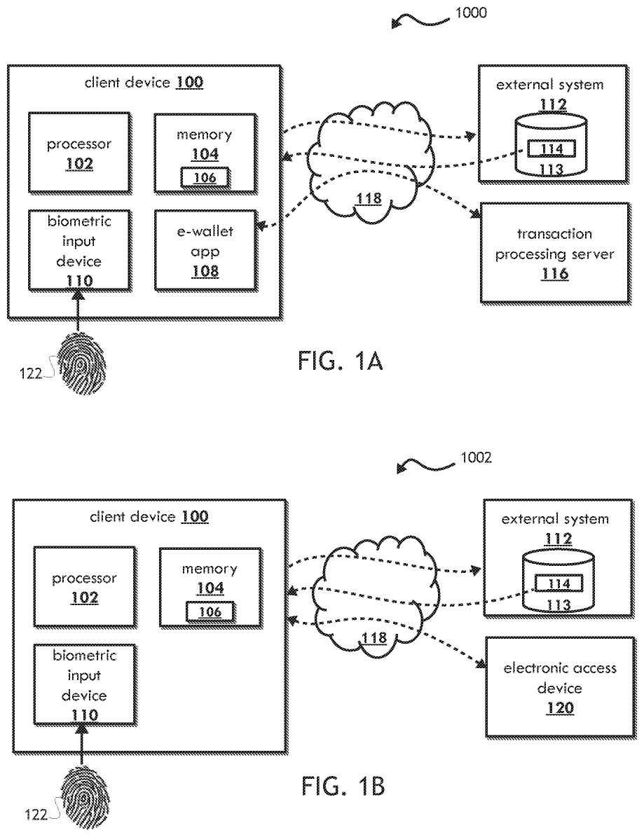

Referring now to FIG. 1A, a system 1000 for authenticating biometric inputs is shown according to a non-limiting embodiment. A client device 100 is in communication with an external system 112 and a transaction processing server 116. The external system 112 may be separate and remote from the transaction processing server 116 or, in other non-limiting embodiments, the external system 112 may be part of and/or coextensive with the transaction processing server 116. The client device 100 in FIG. 1A is in communication with the external system 112 and transaction processing server 116 via a network environment 118, such as a public or private network. However, it will be appreciated that the client device 100 may communicate with the external system 112 and transaction processing server 116 via separate network environments and/or other communication channels.

With continued reference to FIG. 1A, the client device 100 includes and/or is in communication with a processor 102, a memory 104, an electronic wallet application 108, and a biometric input device 110. The memory 104, electronic wallet application 108, and biometric input device 110 may each be in communication with the processor 102. It will be appreciated that various other arrangements may be used. For example, in some non-limiting embodiments, a web browser, mobile device operating system, and/or other software application may be used instead of or in addition to an electronic wallet application 108. In non-limiting embodiments, the processor 102, memory 104, biometric input device 110, and electronic wallet application 108 may be integrated with a mobile device, such as a smartphone or wearable device. For example, the biometric input device 110 may include a camera or fingerprint scanner integrated into a mobile device. In other non-limiting embodiments, one or more of the processor 102, memory 104, biometric input device 110, and/or electronic wallet application 108 may be external to and in communication with the client device 100. For example, the biometric input device 110 may be external to the client device 100 and in communication with the processor 102.

Still referring to FIG. 1A, in non-limiting embodiments the client device 100 communicates a request to the external system 112 via the network environment 118. The external system 112 may include or more server computers, other client devices, data storage devices, and/or the like, arranged remotely from the client device 100 and programmed or configured to communicate with the client device 100 via the network environment 118. In non-limiting embodiments, the external system 112 includes a server computer and at least one data storage 113 device. The external system 112, in response to the request, communicates at least one code 114 to the client device 100. The at least one code 114 may be stored on the data storage device 113 of the external system 112 or, in other non-limiting embodiments, may be stored on one or more other data storage devices or other external systems in communication with the external system 112. Further, in non-limiting embodiments the external system 112 may communicate the at least one code 114 to the client device 100 without receiving a request. For example, the external system 112 may communicate the at least one code 114 in response to an input, at a predetermined time, and/or at a predetermined interval. In non-limiting embodiments, the at least one code 114 may comprise one or more strings of binary, alphanumeric, hexadecimal, and/or other data representations. It will be appreciated that the at least one code may be arranged in any manner and/or type of data structure.

In a non-limiting embodiment, and with continued reference to FIG. 1A, the at least one code 114 may be communicated to the client device 100 as part of a registration process. After and/or in response to receiving the at least one code 114, the processor 102 of the client device 100 may generate a first biometric code 106 based at least partially on the at least one code 114 received from the external system 112 and at least one biometric input received by the biometric input device 110. For example, the first biometric code 106 may be generated by combining the at least one code 114 with at least one biometric input. In non-limiting embodiments, the client device 100 combines the at least one code 114 and the at least one biometric input by hashing the respective values together using one or more one-way hash functions, such as but not limited to a Secure Hash Algorithm (SHA). For example, the respective values of the at least one code 114 and the at least one biometric input may be combined using an exclusive or (XOR) operation or other digital logic gate. In other non-limiting embodiments, the at least one code 114 and the at least one biometric input may be combined using any other type of algorithm, such as a reversible encryption algorithm. It will be appreciated that other data, such as but not limited to seed values, device identifiers, user identifiers, and/or the like, may be combined with the at least one code 114 and the at least one biometric input to generate the first biometric code 106. Moreover, one or more additional data processing operations, such as but not limited to additional cryptographic functions, may be applied to generate the first biometric code 106. The first biometric code 106 is stored in memory 104 on the client device 100. In some examples, the first biometric code 106 may be further encrypted before being stored in memory 104. In some non-limiting embodiments, the at least one code 114 may be deleted and/or removed from the client device 100 after the first biometric code 106 is generated.

Still referring to FIG. 1A, in non-limiting embodiments and after the registration process, the client device 100 may be used to initiate a transaction with the transaction processing server 116. For example, the electronic wallet application 108 may be used to initiate a payment transaction with the transaction processing server 116. The client device 100 (and/or electronic wallet application 108) may communicate a request to the external system 112 to receive the at least one code 114. In non-limiting embodiments, the external system 112 may be the same external system that previously provided the at least one code 114 during the registration process while, in other non-limiting examples, multiple external systems may be used and accessed to provide the at least one code 114. The client device 100 (and/or electronic wallet application 108) may prompt a user through the client device 100 to provide one or more biometric inputs. In other non-limiting embodiments, the user may be prompted to provide a biometric input prior to requesting the at least one code 114. In further non-limiting embodiments, the biometric input may be provided without prompting a user. The processor 102 of the client device 100 generates a second biometric code based on the one or more biometric inputs and the at least one code 114 received from the external system. The second biometric code may be generated in the same way that the first biometric code 106 was generated.

With continued reference to FIG. 1A, after generating the second biometric code, the processor 102 of the client device 100 compares the second biometric code with the first biometric code 106 stored in memory 104. In response to determining that the first biometric code 106 matches the second biometric code, the client device 100 (and/or electronic wallet application 108) may authenticate the user and/or the transaction. For example, the client device 100 (and/or electronic wallet application 108), in response to determining that the first and second biometric codes match, may authenticate the user and communicate an authentication message and/or a transaction message to the transaction processing server 116. In some non-limiting embodiments, the transaction may be processed by the transaction processing server 116 in response to receiving the authentication message and/or transaction message. In other non-limiting embodiments, the client device 100 may also communicate credentials and/or other data for processing the transaction, and the transaction processing server 116 may also authenticate the user through an additional authentication process.

Still referring to FIG. 1A, because the first biometric code and second biometric code are compared on the client device 100, non-limiting embodiments may be used with existing transaction processing servers 116 without requiring server-side modification. In such examples, the client device 100 authenticates the user and then proceeds initiating the transaction with the transaction processing server 116. In this manner, the client device 100 authenticates the user of the client device 100. However, in some non-limiting embodiments, the transaction processing server 116 may authenticate the user and/or transaction in any number of ways. As an example, the transaction processing server 116 may determine that the client device 100 is authorized to be used for transactions, may determine that correct user credentials were input into the client device 100, may determine that a device identifier of the client device 100 matches a registered device identifier for the client device 100, and/or the like. In some non-limiting embodiments, a copy of the first biometric code may be stored by the transaction processing server 116 and/or in a data storage device in communication with the transaction processing server 116. In such examples, the client device may communicate the second biometric code to the processing server 116. The second biometric code may be communicated with a transaction message, separately, and/or in any other manner. The transaction processing server 116 may then compare the received second biometric code with the stored copy of the first biometric code to authenticate the user and/or the transaction.

In non-limiting embodiments, a user is authenticated for at least one of the following transactions: a payment transaction, granting access to a facility, and/or granting access to a system. It will be appreciated, however, that non-limiting embodiments may be used with any transaction involving authentication and that, in further non-limiting embodiments, a user may be authenticated without involving a transaction. In the non-limiting embodiment shown in FIG. 1A, the transaction is a payment transaction. In response to authenticating the user, the client device 100 (and/or electronic wallet application 108) may generate a transaction message comprising transaction data such as, for example, a transaction value, one or more account identifiers, a merchant identifier, a merchant category, and/or other like transaction parameters. The transaction message may include an indication that the user was authenticated, such as a certificate, flag, and/or the like. It will be appreciated that various other arrangements are possible.

Referring now to FIG. 1B, a system 1002 for authenticating biometric inputs is shown according to another non-limiting embodiment. In FIG. 1B, the transaction comprises granting access to a facility or system. A client device 100 is in communication with an external system 112 and an electronic access device 120. Although FIG. 1B depicts the client device 100 in communication with the external system 112 and electronic access device 120 via the network environment 118, it will be appreciated that the client device 100 may communicate with the external system 112 and electronic access device 120 via separate network environments or other communication channels. For example, the client device 100 may communicate with the electronic access device 120 via Bluetooth®, Near-Field Communication (NFC), a WiFi network, an Internet connection, a wired connection, and/or the like. The client device 100 may additionally or alternatively communicate with a server computer or remote device (not shown in FIG. 1B) that is, in turn, in communication with the electronic access device 120. As used herein, the term “electronic access device” may refer to one or more devices, systems, and/or software applications programmed or configured to grant access to a system or facility. As an example, an electronic access device may include a server computer, a locking mechanism, a mobile device, a software application, and/or the like.

With continued reference to FIG. 1B, in non-limiting embodiments in which the transaction comprises granting access to a facility, the electronic access device 120 may comprise a locking mechanism to lock and/or unlock a door, drawer, cabinet, window, and/or other like enclosure or passageway. In some non-limiting embodiments, the client device 100 may detect the presence of the electronic access device 120 and, in response, generate a prompt for a user. The electronic access device 120 may additionally or alternatively detect the presence of the client device 100. The user, through the client device 100, provides a biometric input. The client device 100 receives one or more codes from an external system 112, such as a remote server, the electronic access device 120, or from some other source external to the client device 100. Although FIG. 1B depicts the external system 112 and the electronic access device 120 separately, it will be appreciated that these components may be part of the same system or device. The client device 100 may authenticate the user by generating a biometric code and comparing it to a biometric code 106 already stored on the client device 100. The client device 100, in response to authenticating the user, may then generate an access signal and/or communicate an access signal to the electronic access device 120. An access signal may include, for example, a command, an authentication message, user credentials, and/or any other like data that, when received by the electronic access devices 120, causes the electronic access devices 120 to grant access to a user.

Still referring to FIG. 1B, in non-limiting embodiments in which the transaction comprises granting access to a system, the electronic access device 120 may comprise a secure server or computing device. As an example, the electronic access device 120 may comprise a server computer, a local computer, or a mobile device including one or more software applications programmed to grant access to a system based on credentials, an authentication message, a biometric input, an access signal, and/or other like inputs. In non-limiting embodiments, the electronic access device 120 may comprise the client device 100 itself and/or one or more software applications on the client device 100 configured to grant access to the client device 100 and/or a feature of the client device 100, such as a software application running on the client device 100. For example, the electronic access device 120 may be a software application or operating system on the client device 100 that unlocks features of the mobile device in response to authenticating a user through an integrated biometric input device 110. The external system 112 may include a remote server, the electronic access device 120, or some other source external to the client device 100. The client device 100, in response to authenticating the user, may generate an access signal and/or communicate an access signal to the electronic access device 120.

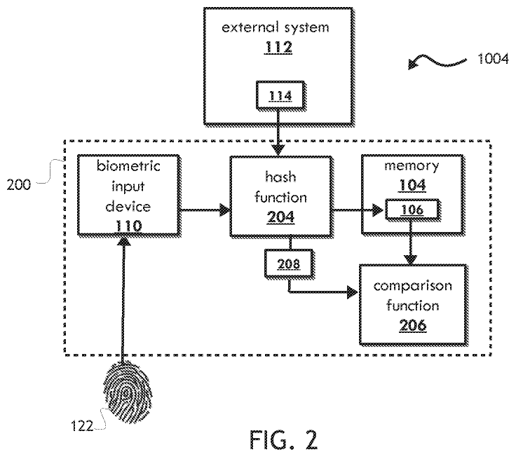

Referring now to FIG. 2, a system 1004 for authenticating biometric inputs is shown according to another non-limiting embodiment. A client device 200 includes a biometric input device 110, memory 104, a hash function 204, and a comparison function 206. The hash function 204 and/or comparison function 206 may be one or more software routines executing on the client device 200. As an example, the hash function 204 and comparison function 206 may be software routines provided by an electronic wallet application. In other examples, the hash function 204 and comparison function 206 may be part of a client device 200 operating system, one or more other software applications, and/or the like. During a registration process, a user provides a biometric input 122 to the biometric input device 110. The hash function 204 receives the biometric input 122 from the biometric input device 110 and at least one code 114 from the external system 112. The hash function 204 combines the biometric input 122 and the at least one code 114 using one or more algorithms to generate a first biometric code 106. As described herein, the first biometric code 106 may also be generated in any number of other ways. The first biometric code 106 is stored on the memory 104 of the client device 200.

With continued reference to FIG. 2, after the first biometric code 106 is stored on the memory 104, the client device 200 may be used to authenticate a user for transactions. The biometric input device 110 again receives a biometric input 122 from a user. The hash function 204 generates a second biometric code 208 based on the biometric input received from the biometric input device 110 and at least one code 114 received from the external system 112. The hash function 204 outputs the second biometric code 208 to the comparison function 206. The comparison function 206 also receives, as an input, the first biometric code 106 from the memory 104. The comparison function 206 compares the second biometric code 208 with the first biometric code 106. In response to determining that the second biometric code 208 matches the first biometric code, the comparison function 206 may return an output that indicates that the user is authenticated. In response to determining that the second biometric code 208 does not match the first biometric code 106, the comparison function 206 may return an output that indicates that the user is not authenticated. The output of the comparison function 206 may be in any number of forms such as, for example, a Boolean value (e.g., “true” or “false”), a signal, an entry in a database, a function call to generate an authentication message, and/or the like. The output of the comparison function 206 may be provided to a software application executing on the client device 200, such as an electronic wallet application, or to an external system or device.

In non-limiting embodiments, the at least one code 114 provided by the external system 112 may be one or more codes of a number of possible codes. For example, the at least one code 114 used to generate the first biometric code 106 and the second biometric code 208 may be specific to a user, the client device 200, a merchant, an issuer institution, a transaction service provider, and/or an electronic wallet application or provider, as examples. In non-limiting embodiments, each user or client device 200 is associated with a unique identifier and the at least one code is selected from a plurality of codes based on that unique identifier. The unique identifier may include, for example, an account identifier, a user name, a device identifier, a numeric value, and/or the like. In examples, the at least one code may correspond with one or more unique identifiers of different users. For example, each unique identifier may be associated with a code unique to that user identifier. In other examples, multiple unique identifiers (e.g., a range or grouping of unique identifiers) may be associated with a code unique to those multiple unique identifiers. For example, if the unique identifier is a user name, the code may be selected based on one or more letters of the user name (e.g., all users with a name starting with “A” may correspond to one unique code, etc.). Various other arrangements are possible.

In non-limiting embodiments, the first biometric code and second biometric code may be generated based on an algorithm and/or algorithm input (e.g., a seed or key) that is unique or specific to a user, the client device 200, a merchant, an issuer institution, a transaction service provider, and/or an electronic wallet application or provider, as examples. In non-limiting embodiments, each user or client device 200 may be associated with an algorithm or algorithm input. For example, a unique identifier for a user or the client device 200 may correspond to an algorithm or algorithm input to be used with that user or that client device. In other examples, multiple unique identifiers (e.g., a range or grouping of unique identifiers) may be associated with an algorithm or algorithm input unique to those multiple identifiers. For example, if the unique identifier is a user name, the algorithm or algorithm input may be selected based on one or more letters of the user name (e.g., all users with a name starting with “A” may correspond to an algorithm or algorithm input, etc.). Various other arrangements are possible.

In non-limiting embodiments, the at least one code, algorithm, and/or algorithm input may be changed in response to a predetermined time interval, a security breach, a user request, and/or other like events. In such examples, a user may be prompted through the client device to begin a new registration process in which a new biometric input is provided. In such examples, a new biometric code may be generated based on one or more new codes and stored on the client device 200 for later use.

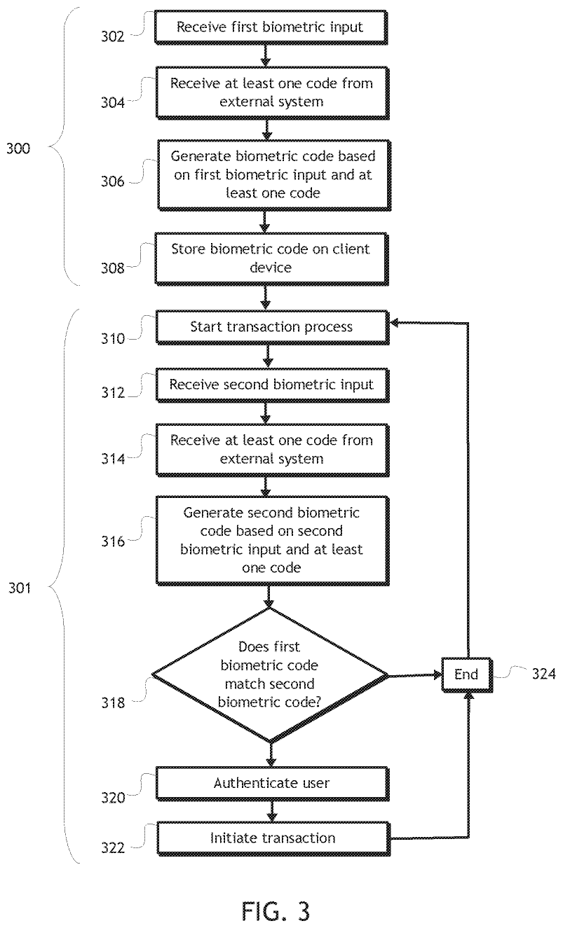

Referring now to FIG. 3, a flow diagram for a method of processing biometric inputs is shown according to a non-limiting embodiment. A registration process 300 begins with receiving a first biometric input at step 302. At step 304, at least one code is received from an external system, such as a remote server, a local computer, an electronic access device, and/or the like. The at least one code and the first biometric input may be received in any order and/or contemporaneously. At step 306, the client device generates a first biometric code based on the first biometric input received at step 302 and the at least one code received from the external system at step 304. The first biometric code is stored on the client device at step 308. Once the registration process 300 is complete, the user may initiate a transaction process 301 with the client device.

With continued reference to FIG. 3, the transaction process 301 is commenced at step 310 in response to user input, such as a selection of an option on a client device. The transaction process may also be commenced at step 310 in response to a signal received by the client device from a server or device. At step 312, a second biometric input is received. The second biometric input may be the same type of biometric input as the first biometric input. In some examples, the client device may prompt the user to provide the second biometric input. At step 314, at least one code is received from an external system. The external system may be the external system as discussed in connection with step 304 or, in other examples, may be a separate external system. The at least one code and the second biometric input may be received in any order and/or contemporaneously. At step 316, a second biometric code is generated based on the second biometric input and the at least one code received from the external system. At step 318, the client device determines if the first biometric code stored on the client device matches the second biometric code by comparing the respective values of the biometric codes. In response to determining that the first biometric code and second biometric code match, the method proceeds to step 320 and the user is authenticated. At step 322, following authentication, a transaction is initiated automatically or in response to user input. If the biometric codes do not match at step 318, the method may end at step 324. The transaction process 301 may proceed back to step 310 for a next transaction.

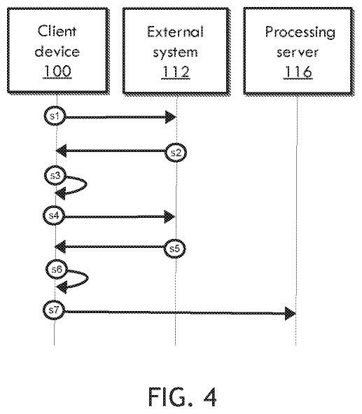

Referring now to FIG. 4, a sequence diagram is shown according to a non-limiting embodiment. At step s1, a client device 100 transmits a request to an external system 112. In response to the request, at step s2, the external system 112 transmits at least one code to the client device 100. The at least one code may be selected based on the client device, a user of the client device, and/or some other criteria. At step s3, the client device generates a first biometric code based on one or more biometric inputs and the at least one code received at step s2. At step s4, the client device is ready to initiate a transaction and, automatically or in response to an input, transmits another request to the external system 112. In response to the request, at step s5, the external system 112 transmits the at least one code to the client device 100. At step s6, the client device generates a second biometric code based on one or more biometric inputs and the at least one code received at step s5, and determines if the second biometric code matches the first biometric code. In response to determining that the biometric codes match, the client device 100, at step s7, may communicate a transaction message and/or authentication message to a transaction processing server 116 to initiate a transaction or as part of an ongoing transaction process.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method of authenticating biometric inputs on a client device, comprising:
receiving, on the client device, at least one first biometric input from a user;
receiving, on the client device, at least one code from an external system;
generating, with the client device, a first biometric code based at least partially on the at least one first biometric input and the at least one code;
storing the first biometric code on the client device;
receiving, on the client device, at least one second biometric input from the user;
receiving, on the client device, the at least one code from an external system;
generating, with the client device, a second biometric code based at least partially on the at least one second biometric input and the at least one code; and
authenticating the user by comparing, with the client device, the first biometric code stored on the client device with the second biometric code.

2. The computer-implemented method of claim 1, further comprising initiating, with the client device, a transaction in response to authenticating the user.

3. The computer-implemented method of claim 2, wherein the transaction comprises a payment transaction, and wherein initiating the transaction comprises:
generating, with the client device, a transaction message; and
communicating the transaction message to a transaction processing system.

4. The computer-implemented method of claim 2, wherein the transaction comprises granting access to a facility, and wherein initiating the transaction comprises communicating an access signal to an electronic access device at the facility, the access signal configured to cause the electronic access device to unlock.

5. The computer-implemented method of claim 2, wherein the transaction comprises granting access to a system, and wherein initiating the transaction comprises at least one of the following: communicating an access signal to a server, communicating an access signal to a local computer, communicating user credentials to a server, communicating user credentials to a local computer, communicating an access signal to an electronic access device, or any combination thereof.

6. The computer-implemented method of claim 1, wherein the first biometric code is generated by hashing the at least one first biometric input with the at least one code, and wherein the second biometric code is generated by hashing the at least one second biometric input with the at least one code.

7. The computer-implemented method of claim 1, wherein the user is associated with a unique identifier, and wherein the at least one code is selected from a plurality of codes based at least partially on the unique identifier.

8. A system for authenticating biometric inputs on a client device, comprising:
(a) at least one data storage device; and
(b) at least one processor in communication with the at least one data storage device and at least one biometric input device, the at least one processor programmed or configured to:
(i) receive at least one first biometric input from a user via the at least one biometric input device;
(ii) receive at least one code from an external system;
(iii) generate a first biometric code based at least partially on the at least one first biometric input and the at least one code;
(iv) store the first biometric code on the data storage device;
(v) receive at least one second biometric input from the user via the at least one biometric input device;
(vi) receive the at least one code from an external system;
(vii) generate a second biometric code based at least partially on the at least one second biometric input and the at least one code; and
(viii) authenticate the user by comparing the first biometric code stored on the at least one data storage device with the second biometric code.

9. The system of claim 8, wherein the at least one processor is further programmed or configured to (ix) initiate a transaction in response to authenticating the user.

10. The system of claim 9, wherein the transaction comprises a payment transaction, and wherein the at least one processor initiates the transaction by:
generating a transaction message; and
communicating the transaction message to a transaction processing system.

11. The system of claim 9, wherein the transaction comprises granting access to a facility, and wherein the at least one processor initiates the transaction by communicating an access signal to an electronic access device, the access signal configured to cause the electronic access device to unlock.

12. The system of claim 8, wherein the transaction comprises granting access to a system, and wherein the at least one processor initiates the transaction by at least one of the following: communicating an access signal to a server, communicating an access signal to a local computer, communicating user credentials to a server, communicating user credentials to a local computer, communicating an access signal to an electronic access device, or any combination thereof.

13. The system of claim 8, wherein the user is associated with a unique identifier, and wherein the at least one code is selected from a plurality of codes based at least partially on the unique identifier.

14. The system of claim 8, wherein the first biometric code is generated by hashing the at least one first biometric input with the at least one code, and wherein the second biometric code is generated by hashing the at least one second biometric input with the at least one code.

15. A computer program product for authenticating biometric inputs on a client device, comprising at least one non-transitory computer-readable medium including program instructions that, when executed by at least one processor of a client device, cause the client device to:
receive at least one first biometric input from a user via at least one biometric input device;
receive at least one code from an external system;
generate a first biometric code based at least partially on the at least one first biometric input and the at least one code;
store the first biometric code on the client device;
receive at least one second biometric input from the user via the at least one biometric input device;
receive the at least one code from an external system;
generate a second biometric code based at least partially on the at least one second biometric input and the at least one code; and
authenticate the user by comparing the first biometric code stored on the client device with the second biometric code.

16.-23. (canceled)
